(19) United States
(12) Patent Application Publication
(10) Pub. No.: US 2025/0341747 A1
(43) Pub. Date: Nov. 6, 2025

(54) DISPLAY APPARATUS

(71) Applicant: SAMSUNG ELECTRONICS CO., LTD., Suwon-si (KR)

(72) Inventors: Chanhong Park, Suwon-si (KR); Keunbae Jeon, Suwon-si (KR); Jongseong Kim, Suwon-si (KR); Sungho Choi, Suwon-si (KR)

(73) Assignee: SAMSUNG ELECTRONICS CO., LTD., Suwon-si (KR)

(21) Appl. No.: 19/271,359

(22) Filed: Jul. 16, 2025

Related U.S. Application Data
(63) Continuation of application No. PCT/KR2023/020156, filed on Dec. 8, 2023.

(30) Foreign Application Priority Data
Feb. 16, 2023 (KR) 10-2023-0020981

(51) Int. Cl. G02F 1/1362; G02F 1/1368

(52) U.S. Cl. CPC G02F 1/136204; G02F 1/136209; G02F 1/136222; G02F 1/1368; G02F 2201/50

(57) ABSTRACT

A display apparatus includes a first substrate, a second substrate disposed on the first substrate, a sealant provided between the first substrate and the second substrate, and an indium tin oxide (ITO) pattern disposed on an outer edge between the first substrate and the second substrate and configured to prevent generation of static electricity.

### CROSS-REFERENCE TO RELATED APPLICATIONS

This application is a continuation application of International Application No. PCT/KR2023/020156 filed on Dec. 8, 2023, which claims priority to Korean Patent Application No. 10-2023-0020981, filed on Feb. 16, 2023, in the Korean Intellectual Property Office, the disclosures of which are incorporated by reference herein in their entireties.

### FIELD

The disclosure relates to a display apparatus including a liquid crystal display device for electrostatic discharge protection.

### BACKGROUND

In recent years, flat panel display devices, such as liquid crystal displays (LCDs), plasma display panels (PDPs), and organic light emitting diodes (OLEDs) have been rapidly developing in place of cathode ray tubes (CRTs) display devices.

Among such devices, LCDs are widely used in a variety of devices because they are thinner and lighter than other display devices, and have lower power consumption and lower driving voltage.

In general, an LCD device includes a liquid crystal panel that displays a screen and a backlight unit that provides light to the liquid crystal panel. To discharge electrostatic discharge (ESD) generated by the liquid crystal panel, an additional process is required, in which separate mechanical structures or auxiliary materials such as gasket tape are attached. This leads to increased material costs, additional work during production, and misapplication of specifications.

In addition, when such auxiliary materials cannot be added, the thickness of the indium tin oxide (ITO) on the upper layer of the liquid crystal panel increases to enhance durability, which causes problems such as increased cell production time and/or increased raw material costs.

### SUMMARY

An embodiment of the disclosure may provide a display apparatus including a liquid crystal display device for electrostatic discharge protection.

An embodiment of the disclosure may provide a display apparatus capable of electrostatic discharge protection by a transparent electrode (e.g., ITO) portion.

An embodiment of the disclosure may provide a display apparatus capable of preventing electrostatic discharge (ESD) from entering by providing a transparent electrode (e.g., ITO) portion inside an LCD cell.

An embodiment of the disclosure may provide a display apparatus capable of electrostatic discharge protection by providing a transparent electrode (e.g., ITO) portion in an edge area of an LCD cell.

According to an aspect of the disclosure, a display apparatus includes: a first substrate; a second substrate disposed on the first substrate; a sealant provided between the first substrate and the second substrate; and an indium tin oxide (ITO) pattern disposed on an outer edge between the first substrate and the second substrate and configured to prevent generation of static electricity.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a perspective view illustrating a display apparatus according to an embodiment,

FIG. 2 is an exploded perspective view illustrating the display apparatus according to an embodiment,

FIG. 3 is a view illustrating a cross-section of a liquid crystal display device shown in FIG. 2,

FIG. 4 is a view illustrating a path through which electrostatic discharge is introduced into the liquid crystal display device according to an embodiment,

FIG. 5 is a cross-sectional view illustrating an ITO pattern provided in the liquid crystal display device according to an embodiment,

FIG. 6 is a schematic view illustrating a connection state between the IPO pattern and a ground of the liquid crystal display device according to an embodiment,

FIG. 7 is a cross-sectional view illustrating an installation position of an ITO pattern of the liquid crystal display device according to an embodiment,

FIG. 8 is a cross-sectional view illustrating an installation position of an ITO pattern of the liquid crystal display device according to an embodiment.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Hereinafter, various embodiments of the disclosure will be described in detail with reference to the accompanying drawings.

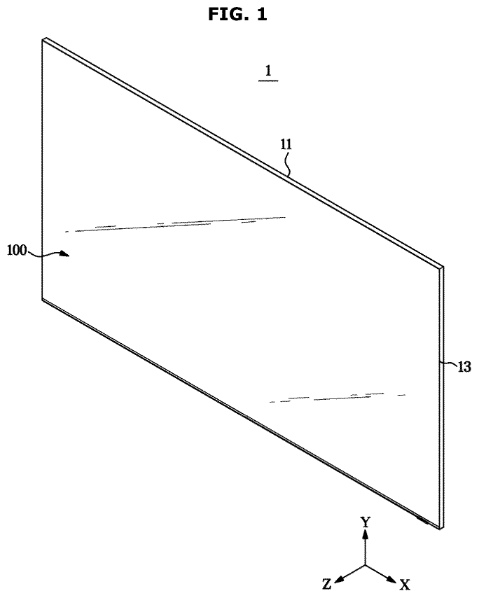

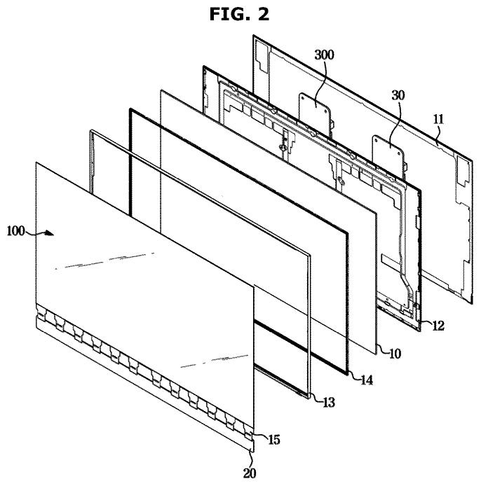

FIG. 1 is a perspective view illustrating a display apparatus according to an embodiment, and FIG. 2 is an exploded perspective view illustrating the display apparatus according to an embodiment.

As shown in FIGS. 1 and 2, a display apparatus 1 may be a device that processes image signals received from an external source and visually displays the processed images. The following description is based on the example where the display apparatus 1 is a television (TV), but the present disclosure is not limited thereto. For example, the display apparatus 1 may be implemented in various forms, such as a monitor, a portable multimedia device, a portable communication device, or the like, and the display apparatus 1 is not limited to any particular form as long as it is a device that visually displays images.

The display apparatus 1 may be a large format display (LFD) installed outdoors, such as on a building rooftop or at a bus stop. Here, “outdoors” may not be necessarily limited to outdoor locations, and the display apparatus 1 according to an embodiment may also be installed in indoor locations, such as subway stations, shopping malls, movie theaters, companies, and stores, where a large number of people may enter and exit, even if indoors. The display apparatus 1 may receive content including video signals and audio signals from various content sources and output video and audio corresponding to the video signals and audio signals. For example, the display apparatus 1 may receive content data through a broadcast receiving antenna or a wired cable, receive content data from a content playback device, or receive content data from a content delivery server of a content provider.

The display apparatus 1 may be equipped with components for displaying images or performing various functions.

The display apparatus 1 may be configured to display a screen. In some embodiments, the display apparatus 1 may include a display panel (hereinafter referred to as a ‘liquid crystal panel’) that displays an image in a front direction (e.g., X direction).

A plurality of pixels is formed on a liquid crystal panel 100, and a screen displayed on the liquid crystal panel 100 may be formed by a combination of light emitted from the plurality of pixels. For example, a single screen may be formed by combining the light emitted from the plurality of pixels in a mosaic pattern.

Each of the plurality of pixels may emit light of various brightness levels and various colors. Specifically, each of the plurality of pixels may include sub-pixels, and the sub-pixels may include red sub-pixels capable of emitting red light, green sub-pixels capable of emitting green light, and blue sub-pixels capable of emitting blue light. For example, red light may represent light with a wavelength of approximately 700 nm (one billionth of a meter) to 800 nm. Green light may represent light with a wavelength of approximately 500 nm to 600 nm. Blue light may represent light with a wavelength of approximately 400 nm to 500 nm.

Each of the plurality of pixels may emit light of various brightness levels and various colors by a combination of light emitted from the sub-pixels, green sub-pixels, and blue sub-pixels.

The display apparatus 1 may include a printed circuit board 20 that transmits information to the liquid crystal panel 100. The printed circuit board 20 may be disposed on a lower side of the liquid crystal panel 100. A chip on film (COF) 15 that electrically connects the printed circuit board 20 and the liquid crystal panel 100 may be disposed on the lower side of the liquid crystal panel 100.

The COF 15 may extend from a lower side portion of the liquid crystal panel 100 and connect to the printed circuit board 20, and may be bent at the lower side of the liquid crystal panel 100 and extend to a rear side of a top chassis 13. The printed circuit board 20 may be disposed on the rear side of the top chassis 13.

The COF 15 may include a film printed circuit board formed in a film shape and a semiconductor chip mounted on the film printed circuit board, respectively. The COF 15 may have one end connected to a lower end side of the liquid crystal panel 100 and the other end connected to the printed circuit board 20, so that image signals may be transmitted from the printed circuit board 20 to the liquid crystal panel 100. The specific liquid crystal panel 100 will be described later.

The display apparatus 1 may include a backlight unit (BLU) 10, the liquid crystal panel 100 that blocks or transmits light emitted from the BLU 10, a power assembly 30 that supplies power to the BLU 10 and the liquid crystal display device 100, and a control assembly 300 that controls operation of the liquid crystal panel 100.

The display apparatus 1 may include the top chassis 13, a middle mold 14, a bottom chassis 12, and a rear cover 11 for supporting the liquid crystal panel 100, the BLU 10, the power assembly 30, and the control assembly 300.

However, the power assembly 30 and the control assembly 300 may be provided as a single assembly, or the power assembly 30 and the control assembly 300 may also be provided separately. In the latter case, the arrangement may be reversed from the arrangement shown in FIG. 2, such that the control assembly 300 is disposed to the right (e.g., Y direction) of the power assembly 30.

The BLU 10 may include a point light source that emits white light. In addition, the BLU 10 may refract, reflect, and scatter light to convert the light emitted from the point light source into a uniform planar light. As such, the BLU 10 may emit uniform planar light toward the front by refracting, reflecting, and scattering the light emitted from the point light source.

The liquid crystal panel 100 may be arranged in front of the BLU 10 (e.g., X direction) and block or transmit light emitted from the BLU 10 to form an image.

A front surface of the liquid crystal panel 100 may form a screen of the display apparatus 1, and the liquid crystal panel 100 may form a plurality of pixels. The liquid crystal panel 100 may block or transmit the light of the BLU 10 independently of the plurality of pixels. In addition, the light transmitted by the plurality of pixels may form an image displayed on the screen.

The power assembly 30 may include a power circuit that supplies power to the liquid crystal display device 100 and the BLU 10. The power circuit may supply power to the control assembly 300, the BLU 10, and the liquid crystal panel 100.

The control assembly 300 may include a control circuit that controls operation of the liquid crystal panel 100 and the BLU 10. For example, the control circuit may process video signals and/or audio signals received from an external content source. The control circuit may transmit image data to the liquid crystal display device 100. The control assembly 300 may further include a drive printed circuit board 330, which will be described later.

The drive printed circuit board 330 may further include a common voltage (Vcom) generator 320 that generates a common voltage Vcom and compares the common voltage applied to the liquid crystal panel 100 with a reference common voltage to compensate for the common voltage Vcom with the difference voltage.

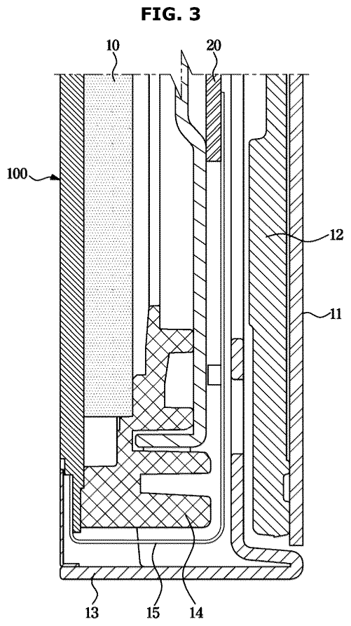

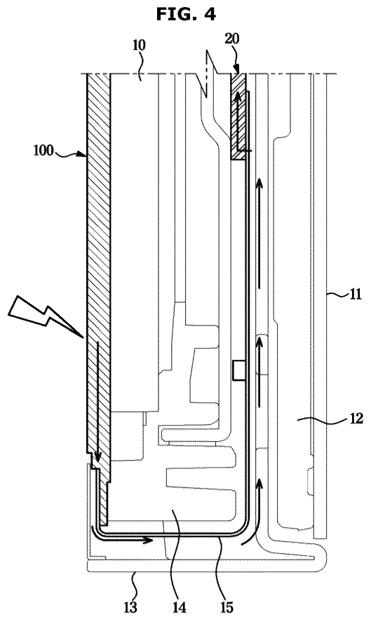

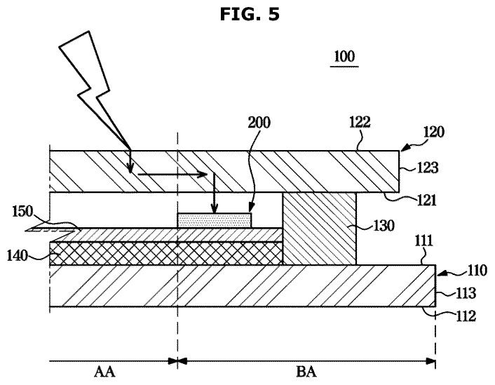

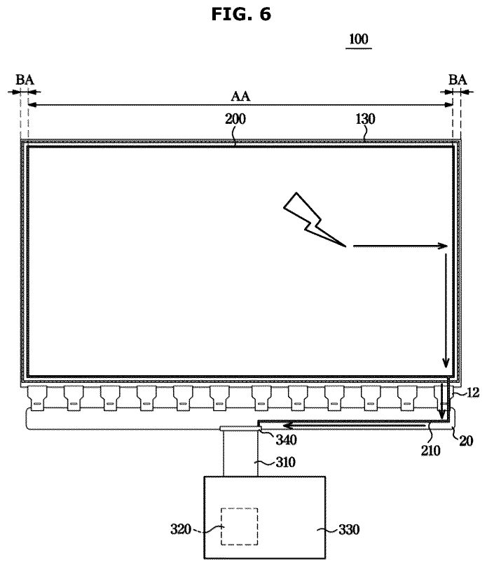

FIG. 3 is a cross-sectional view illustrating the liquid crystal display device shown in FIG. 2, FIG. 4 is a view illustrating a path through which electrostatic discharge is introduced into the liquid crystal display according to an embodiment, FIG. 5 is a cross-sectional view illustrating an ITO pattern provided in the liquid crystal display device according to an embodiment, and FIG. 6 is a view schematically illustrating a connection state between the ITO pattern and a ground of the liquid crystal display device according to an embodiment.

As shown in FIGS. 3 to 6, the liquid crystal panel 100 may form the screen of the display apparatus 1 and may be a liquid crystal display device.

In some embodiments, the liquid crystal display device includes a thin film transistor (TFT) substrate (e.g., TFT Glass), a color filter (CF) substrate (e.g., CF Glass) disposed on the TFT substrate, a sealant provided between the TFT substrate and the CF substrate, and an indium tin oxide (ITO) pattern disposed on an outer edge between the TFT substrate and the CF substrate and configured to prevent generation of electrostatic.

The liquid crystal display device 100 may independently block or pass the light of the BLU 10 for each of the plurality of pixels.

The liquid crystal display device 100 may include an active area AA where an image is displayed and a black matrix area BA where an image is not displayed. The active area AA may be referred to as a display area. The black matrix area BA may be referred to as a non-display area.

The black matrix area BA may be arranged around the active area AA. The black matrix area BA may be arranged in a perimeter of the active area AA. The active area AA may include a plurality of pixel areas.

The liquid crystal display device 100 may include a first substrate 110 and a second substrate 120. The first substrate 110 may be divided into the active area AA and the black matrix area BA. The second substrate 120 may be divided into the active area AA and the black matrix area BA. The first substrate 110 and the second substrate 120 may be insulating substrates and may be formed of glass or plastic. A liquid crystal layer may be provided between the first substrate 110 and the second substrate 120. The liquid crystal layer may be disposed in the active area AA.

The active area AA of the liquid crystal display device 100 may include a plurality of pixel areas. On the first substrate 110, gate lines may be formed in one direction and data lines may be formed in a direction different from the one direction. The gate lines and the data lines may intersect each other to define pixel areas in the active area AA.

In addition, the gate lines may extend to the black matrix area BA to connect with gate pads. The data lines may extend to the black matrix area BA to connect with date pads.

In the active area AA, an intersection area of the gate lines and the data lines may be formed on the first substrate 110, and a thin film transistor (TFT) may be formed in the intersection area. The first substrate 110 may be a TFT substrate.

The liquid crystal display device 100 may include a black matrix and a color filter. The liquid crystal display device 100 may include a color filter (CF) substrate including the black matrix and the color filter. The CF substrate may be the second substrate 120 facing the first substrate 110.

A sealant 130 may be provided between the first substrate 110 and the second substrate 120 of the liquid crystal display device 100. The sealant 130 may be configured to bond the first substrate 110 and the second substrate 120. The sealant 130 may be provided on an edge between the first substrate 110 and the second substrate 120 to bond the first substrate 110 and the second substrate 120. The sealant 130 may be provided on all edges of the first substrate 110 and the second substrate 120. The sealant 130 may be located in the black matrix area BA of the liquid crystal display device 100.

Electrostatic discharge (ESD) may be applied to an interior of the liquid crystal display device 100 through the second substrate 120 exposed to a user. ESD may be applied to the first substrate 110 through the second substrate 120 of the liquid crystal display device 100. The top chassis 13 of the display apparatus 1 may be made of non-conductive plastic. The rear cover 11 and the bottom chassis 12 of the display apparatus 1 may be made of non-conductive plastic or the like. In this case, ESD may flow into the interior of the liquid crystal display device 100 without being discharged to the outside through the top chassis 13.

An indium tin oxide (ITO) pattern 200 for preventing the generation of such ESD may be provided on an outer border between the first substrate 110 and the second substrate 120 of the liquid crystal display device 100. The ITO pattern 200 may be configured to discharge ESD on an outer surface of the liquid crystal display device 100. The ITO pattern 200 may be configured to discharge ESD that is introduced into the interior of the liquid crystal display device 100 through the second substrate 120 and/or the top chassis 13 exposed to the user.

The ITO pattern 200 may be arranged between the first substrate 110 and the second substrate 120. The ITO pattern 200 may be located at a position adjacent to the sealant 130. The ITO pattern 200 may be located inwardly of the sealant 130. The ITO pattern 200 may be arranged on all edges of the liquid crystal display device 100. The ITO pattern 200 may be located inward of the sealant 130 provided on all edges of the liquid crystal display device 100. The ITO pattern 200 may be located in the black matrix area BA of the liquid crystal display device 100.

The first substrate 110 may be formed in an approximately plate shape. The first substrate 110 may include an inner surface 111, an outer surface 112 opposite to the inner surface 111, and four side surfaces 113 connecting the outer surface 112 and the inner surface 111. The second substrate 120 may be provided with a size and shape corresponding to the first substrate 110.

The second substrate 120 may be formed in an approximately plate shape. The second substrate 120 may include an inner surface 121, an outer surface 122 opposite to the inner surface 121, and four side surfaces 123 connecting the outer surface 122 and the inner surface 121.

The inner surface 111 of the first substrate 110 and the inner surface 121 of the second substrate 120 may be disposed to face each other, and the sealant 130 may be provided along a border defined therebetween.

The ITO pattern 200 may be provided as a transparent electrode. The ITO pattern 200 may be provided as a transparent electrode film.

The ITO pattern 200 may be configured to discharge static electricity by guiding the static electricity into the ITO pattern 200 between the first substrate 110 and the second substrate 120 when static electricity is applied to the interior of the liquid crystal display device 100.

The ITO pattern 200 may be disposed on a top surface of the first substrate 110. The first substrate 110 may further include an insulating layer 150. The ITO pattern 200 may be deposited on the insulating layer 150 of the first substrate 110. In FIG. 5, 140 may be a gate driver on array (GOA) circuit portion 140 provided on the first substrate 110. The GOA circuit portion 140 may be provided between the first substrate 110 and the insulating layer 150.

On one side of the liquid crystal display device 100, a cable 310 that transmits image data to the liquid crystal display device 100 and a drive printed circuit board 330 that processes digital image data and outputs analog image signals may be provided (hereinafter referred to as a ‘panel driver’).

The panel driver 330 may receive image data and power from the power assembly 30 and the control assembly 300 via the cable 310. In addition, the panel driver 330 may provide image data and drive current to the liquid crystal display device 100 via the cable 310.

The cable 310 may electrically connect the power assembly 30 and the control assembly 300 to the panel driver 330, and also electrically connect the panel driver 330 to the liquid crystal display device 100. The cable 310 may include a flexible flat cable or a film cable capable of being bent. The cable 310 may include a ground (GND).

Furthermore, the cable 310 and the panel driver 330 may be integrally implemented as a film cable, a chip on film (COF), a tape carrier packet (TCP), or the like. In other words, the panel driver 330 may be disposed on the cable 310. However, the present disclosure is not limited thereto, and the panel driver 330 may be disposed on the liquid crystal display device 100.

The cable 310 and the panel driver 330 may be disposed on one side of the liquid crystal display device 100. More specifically, the cable 310 and the panel driver 330 may be disposed on an upper side (e.g., Z direction) or a lower side (e.g., −Z direction) of the liquid crystal display device 100 to connect to the power assembly 30 and the control assembly 300.

In addition, the cable 310 and the panel driver 330 may be disposed on the left side (e.g., −Y direction) or the right side (e.g., Y direction) of the liquid crystal display device 100.

The ITO pattern 200 may be connected to the cable 310. The ITO pattern 200 may be connected to a ground 340 of the cable 310. The ITO pattern 200 may be connected to the panel driver 330 connected to the cable 310. The ITO pattern 200 may further include a connection portion 210 for connecting to the cable 310. The connection portion 210 may be provided as a transparent electrode. The ITO pattern 200 may be provided as a transparent electrode film. The connection portion 210 may be made of the same material as the ITO pattern 200.

The connection portion 210 may be arranged to be connected to the ground 340 of the cable 310. The connection portion 210 may be arranged to be connected to the panel driver 330. The ITO pattern 200 may be connected to the cable 310 and the panel driver 330 via the connection portion 210, such that the static electricity entering the interior of the liquid crystal display device 100 flows into the ITO pattern 200 and the connection portion 210 of the ITO pattern 200.

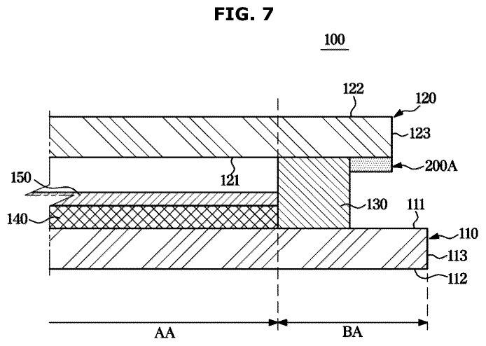

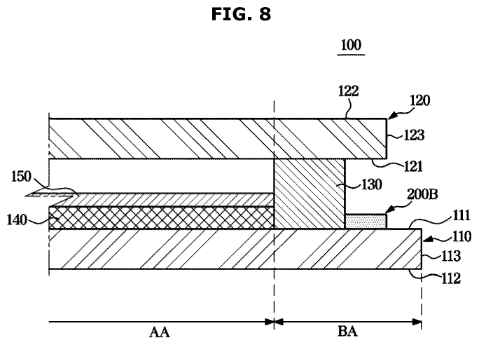

FIG. 7 is a cross-sectional view illustrating an installation position of an ITO pattern of the liquid crystal display device according to an embodiment, and FIG. 8 is a cross-sectional view illustrating an installation position of an ITO pattern of the liquid crystal display device according to an embodiment. In the following, descriptions of parts that are redundant to the above descriptions will be omitted.

As shown in FIGS. 7 and 8, the ITO pattern 200 may be arranged to discharge static electricity that enters the interior of the liquid crystal display device 100 through the second substrate 120 and/or the top chassis 13 exposed to the user.

An ITO pattern 200A may be provided as a transparent electrode. The ITO pattern 200A may be provided as a transparent electrode film. The ITO pattern 200A may be configured to discharge static electricity by introducing the static electricity into the ITO pattern 200A between the first substrate 110 and the second substrate 120 when the static electricity is applied to the interior of the liquid crystal display device 100.

The ITO pattern 200A may be provided between the first substrate 110 and the second substrate 120. The ITO pattern 200A may be located at a position adjacent to the sealant 130.

The first substrate 110 may be formed in an approximately plate shape. The first substrate 110 may include the inner surface 111, the outer surface 112 opposite to the inner surface 111, and the four side surfaces 113 connecting the outer surface 112 and the inner surface 111. The second substrate 120 may be provided in a size and shape corresponding to the first substrate 110.

The second substrate 120 may be formed in an approximately plate shape. The second substrate 120 may include the inner surface 121, the outer surface 122 opposite to the inner surface 121, and the four side surfaces 123 connecting the outer surface 122 and the inner surface 121.

The inner surface 111 of the first substrate 110 and the inner surface 121 of the second substrate 120 may be disposed to face each other, and the sealant 130 may be provided along the border therebetween to bond the first substrate 110 and the second substrate 120.

The ITO pattern 200A may be provided on all four sides of the liquid crystal display device 100. The ITO pattern 200A may be located at a position adjacent to the sealant 130 provided on all four sides of the liquid crystal display device 100. The ITO pattern 200A may be arranged on the inner surface 121 of the second substrate 120. The ITO pattern 200A may be arranged adjacent to the sealant 130 on the inner surface 121 of the second substrate 120. The ITO pattern 200 may be located in the black matrix area BA of the liquid crystal display device 100.

In this case, the ITO pattern 200A may be connected to at least one of the cable 310, the ground 340, or the common voltage Vcom generator 320 via the connection portion 210.

The ITO pattern 200A arranged on all four sides of the liquid crystal display device 100 may prevent discharge of static electricity entering the interior of the liquid crystal display device 100.

In addition, an ITO pattern 200B may be arranged on all four sides of the liquid crystal display device 100. The ITO pattern 200B may be located at a position adjacent to the sealant 130 arranged along the border of the liquid crystal display device 100. The ITO pattern 200B may be arranged on the inner surface 111 of the first substrate 110. The ITO pattern 200B may be arranged adjacent to the sealant 130 on the inner surface 111 of the first substrate 110. In the present embodiment, the ITO pattern is shown as being located on the inner surface of the first substrate or the inner surface of the second substrate, but the present disclosure is not limited thereto. The ITO pattern may be located on an edge adjacent to the sealant between the first substrate and the second substrate of the liquid crystal panel device. In addition, the ITO pattern may be connected to at least one of the cable, the ground, or the common voltage Vcom generator via the connection portion. Such a configuration may allow static electricity entering the interior of the liquid crystal display device to be guided into the ITO pattern.

According to the spirit of the present disclosure, a liquid crystal display device may include a TFT glass substrate (e.g., a TFT glass), a CF substrate disposed on the TFT substrate (e.g., a CF glass), a sealant provided between the TFT substrate and the CF substrate, and an ITO pattern disposed on an outer edge between the TFT substrate and the CF substrate and provided to prevent generation of static electricity, thereby enabling electrostatic discharge protection by the ITO pattern.

The ITO pattern may be located on an inner side of the sealant, and the ITO pattern may be located at a position adjacent to the sealant, thereby preventing electrostatic discharge.

The ITO pattern may be provided along a border of the TFT substrate and the CF substrate, and the ITO pattern may be disposed on a top surface of the thin film transistor substrate, thereby preventing electrostatic discharge.

The TFT substrate may further include an insulating layer, and the ITO pattern may be deposited on the insulating layer.

The ITO pattern may be disposed on a bottom surface of the CF substrate.

The ITO pattern may be connected to a GND, and the ITO pattern may be connected to a Vcom generator. The ITO pattern may include a connection portion connected to the GND and/or the Vcom generator. Accordingly, this may prevent static electricity from entering the interior of the liquid crystal display device.

The liquid crystal display device may include an active area on which an image is displayed and a black matrix area on which an image is not displayed are included, and the sealant and the ITO pattern may be located in the black matrix area.

The display apparatus 1 including a liquid crystal display device 100 according to an embodiment, the liquid crystal display device including the first substrate 110, the second substrate 120 disposed on the first substrate, the sealant 130 provided at an edge between the first substrate 110 and the second substrate, and the ITO pattern 200 arranged along a border between the first substrate 110 and the second substrate 120 and arranged to be located on an inner side of the sealant. Accordingly, electrostatic discharge protection may be provided to an interior of the liquid crystal display device 100 by the ITO pattern 200.

The liquid crystal display device may include an active area on which an image is displayed and a black matrix area located around a perimeter of the active area on which an image is not displayed, and the sealant and the ITO pattern may be located in the black matrix area. The ITO pattern may be located around the sealant. The ITO pattern may be connected to a GND. The ITO pattern may be connected to a common voltage generator.

The ITO pattern may be provided along a border of the first substrate and the second substrate.

The ITO pattern may be disposed on a top surface of the first substrate, and the ITO pattern may be disposed on a bottom surface of the second substrate. Accordingly, static electricity entering the interior of the liquid crystal display device may be prevented.

The first substrate may further include an insulating layer, and the ITO pattern may be deposited on the insulating layer.

According to the spirit of the present disclosure, electrostatic discharge protection may be provided by the transparent electrode (i.e., ITO) portion.

According to the spirit of the present disclosure, electrostatic discharge protection may be prevented by providing the transparent electrode (i.e., ITO) portion inside the LCD cell.

According to the spirit of the present disclosure, electrostatic discharge protection may be provided by providing the transparent electrode (i.e., ITO) portion in an edge area of the LCD cell.

The effects to be obtained from the present disclosure are not limited to those mentioned above, and other effects not mentioned will be apparent to a person skilled in the art to which the present disclosure belongs from the following description.

Although specific embodiments have been illustrated and described above, the present invention is not limited to the embodiments described above, and it will be apparent to those skilled in the art that various changes and modifications can be made without departing from the gist of the technical spirit of the invention described in the claims below.

1. A display apparatus comprising:
a first substrate;
a second substrate disposed on the first substrate;
a sealant provided between the first substrate and the second substrate; and
an indium tin oxide (ITO) pattern disposed on an outer edge between the first substrate and the second substrate and configured to prevent generation of static electricity.

2. The display apparatus of claim 1, wherein the ITO pattern is located on an inner side of the sealant.

3. The display apparatus of claim 1, wherein the ITO pattern is located at a position adjacent to the sealant.

4. The display apparatus of claim 1, wherein the ITO pattern is provided along a border of the first substrate and the second substrate.

5. The display apparatus of claim 1, wherein the ITO pattern is disposed on a top surface of the first substrate.

6. The display apparatus of claim 1, wherein the first substrate further comprises an insulating layer, and the ITO pattern is deposited on the insulating layer.

7. The display apparatus of claim 1, wherein the ITO pattern is disposed on a bottom surface of the second substrate.

8. The display apparatus of claim 1, wherein the ITO pattern is connected to a ground (GND).

9. The display apparatus of claim 8, wherein the ITO pattern is connected to a common voltage generator.

10. The display apparatus of claim 9, wherein the ITO pattern comprises a connection portion connected to at least one of the GND or the common voltage generator.

11. The display apparatus of claim 1, comprising:
an active area on which an image is displayed, and
a black matrix area on which an image is not displayed,
wherein the sealant and the ITO pattern are located in the black matrix area.

12. The display apparatus of claim 1, wherein the first substrate is a thin film transistor (TFT) substrate.

13. The display apparatus of claim 1, wherein the second substrate is a color filter (CF) substrate.
